(19) United States
(12) Patent Application Publication
(10) Pub. No.: US 2014/0055641 A1
(43) Pub. Date: Feb. 27, 2014

(54) SYSTEM FOR RECOGNIZING SURROUNDINGS OF VEHICLE

(71) Applicant: MANDO CORPORATION, Pyeongtaek-si (KR)

(72) Inventor: Min Gwan JO, Yongin-si (KR)

(73) Assignee: MANDO CORPORATION, Pyeongtaek-si (KR)

(21) Appl. No.: 14/011,254

(22) Filed: Aug. 27, 2013

(30) Foreign Application Priority Data
Aug. 27, 2012 (KR) 10-2012-0093868

(51) Int. Cl. H04N 5/235

(52) U.S. Cl. CPC H04N 5/2354
USPC 348/231.3

(57) ABSTRACT

Provided is a system for recognizing surroundings of a vehicle, and more particularly, a system for recognizing surroundings of a vehicle in which a camera and an illumination measurement photo diode system receive power from one vehicle interface connector, and a calculation processing device corrects brightness of a peripheral image of a vehicle photographed by the camera using illumination information measured by the illumination measurement photo diode system to more accurately recognize surroundings of the vehicle.

The system for recognizing surroundings of a vehicle includes a camera mounted on the vehicle and configured to output image information obtained by photographing an image around the vehicle, an illumination measurement photo diode system configured to measure illumination of vehicle surroundings to output illumination information, a calculation processing device configured to receive the image information from the camera and receive the illumination information from the illumination measurement photo diode system to generate and output vehicle surroundings information, and a storage unit configured to receive and store the vehicle surroundings information generated by the calculation processing device.

### BACKGROUND OF THE INVENTION

1. Field of the Invention

The present invention relates to a system for recognizing surroundings of a vehicle, and more particularly, to a system for recognizing surroundings of a vehicle in which a camera and an illumination measurement photo diode system receive power from one vehicle interface connector, and a calculation processing device corrects brightness of a peripheral image of a vehicle photographed by the camera using illumination information measured by the illumination measurement photo diode system to more accurately recognize surroundings of the vehicle.

2. Description of Related Art

The number of vehicles is largely increased as automobile industries are developed. As a result, traffic accidents between vehicles frequently occur due to driving while drowsy, fatigue while driving, poor driving, carelessness, or the like, of a driver or an opposite driver, and traffic accidents due to collisions between vehicles and pedestrians also frequently occur.

In recent times, a camera is installed at a vehicle to recognize surroundings of the vehicle such that a stored image may be used as an evidence of a traffic accident when the traffic accident of the vehicle occurs. A conventional camera receives light in a field of view (FOV) through an optical system, and converts brightness of the light into a digital value through an imaging device. In recognition of the vehicle surroundings through the digital value converted as described above, the conventional camera cannot recognize a subject or cannot easily check a circumstance due to contamination, diffused reflection, disturbed light within a field of vision.

In addition, when a forward side in a running direction is bright, light may be reflected from a dashboard to a windshield of the vehicle, or a screen or the like of a navigation device is reflected at nighttime to exert an influence on photographing of an image of the camera. Accordingly, the image photographed by the conventional camera cannot easily recognize the subject in the field of vision or check a circumstance upon occurrence of the traffic accident under a dark environment.

Further, in general, since there is a temperature difference between the inside and the outside of the vehicle, when a humidity level is high, vapor is condensed on the windshield of the vehicle to generate a fogging phenomenon to block the field of vision, and thus, the image photographed by the conventional camera becomes unclear due to the fogging phenomenon.

In a system using a conventional photo diode used in a circuit of converting an optical variation into an electrical variation using properties of current according to a quantity of light, when the outside is bright, an amount of current flowing through a photo diode is increased, and when the outside is dark, the amount of current flowing through the photo diode is reduced.

The system using the conventional photo diode is used in an illumination sensor or a humidity sensor, and the environment is recognized through output of an individual photo diode. Accordingly, when contamination occurs at a connection section between the photo diode and the optical system or between the vehicle and the system, inaccurate recognition may be output.

In addition, in the conventional art including the system and the camera using the photo diode to recognize the vehicle surroundings, as connectors are separately installed at the system and the camera using the photo diodes to supply power, a large space is required due to the separate connectors in mounting the system and the camera using the photo diodes in the vehicle, thereby reducing spatial utilization.

### SUMMARY OF INVENTION

In order to solve the above-mentioned problems, it is an aspect of the present invention to provide a system for recognizing surroundings of a vehicle capable of improving spatial utilization in the vehicle, in which a camera and an illumination measurement photo diode system are installed, by providing a single vehicle interface connector configured to supply power to the camera and the illumination measurement photo diode system, and more accurately recognizing vehicle surroundings by providing a calculation processing device configured to correct brightness of an image around the vehicle photographed by the camera to generate vehicle surroundings information using illumination information measured by the illumination measurement photo diode system.

In order to accomplish the above-mentioned aspect, the present invention provides a system for recognizing surroundings of a vehicle, including: a camera mounted on the vehicle and configured to output image information obtained by photographing an image around the vehicle; an illumination measurement photo diode system configured to measure illumination of vehicle surroundings to output illumination information; a calculation processing device configured to receive the image information from the camera and receive the illumination information from the illumination measurement photo diode system to generate and output vehicle surroundings information; and a storage unit configured to receive and store the vehicle surroundings information generated by the calculation processing device.

The calculation processing device of the system for recognizing surroundings of the vehicle of the present invention may correct brightness of the image information received from the camera to generate the vehicle surroundings information using the illumination information received from the illumination measurement photo diode system.

The calculation processing device of the system for recognizing surroundings of the vehicle of the present invention may switch the photographing mode of the camera when the illumination measured by the illumination measurement photo diode system is a preset illumination or less.

The system for recognizing surroundings of the vehicle of the present invention may further include a fogging detection photo diode system configured to detect a fogging phenomenon of a window of the vehicle and output fogging information.

The calculation processing device of the system for recognizing surroundings of the vehicle of the present invention may receive the fogging information from the fogging detection photo diode system, and set the photographing mode of the camera to a fogging phenomenon photographing mode when a fogging of the vehicle measured by the fogging detection photo diode system is a preset value or more.

The calculation processing device of the system for recognizing surroundings of the vehicle may set the photographing mode of the camera to the fogging phenomenon photographing mode, the calculation processing device outputs a fogging removal command, and the system may further include an air-conditioning system configured to receive the fogging removal command from the calculation processing device, blows air, from which moisture is removed, to the window of the vehicle, and remove the fogging phenomenon of the vehicle window.

The system for recognizing surroundings of the vehicle may further include a vehicle interface connector connected to the camera, the illumination measurement photo diode system, the fogging detection photo diode system and the calculation processing device to supply power thereto.

### BRIEF DESCRIPTION OF THE INVENTION

The above and other objects, features and advantages of the present invention will become more apparent to those of ordinary skill in the art by describing in detail example embodiments thereof with reference to the attached drawings, in which:

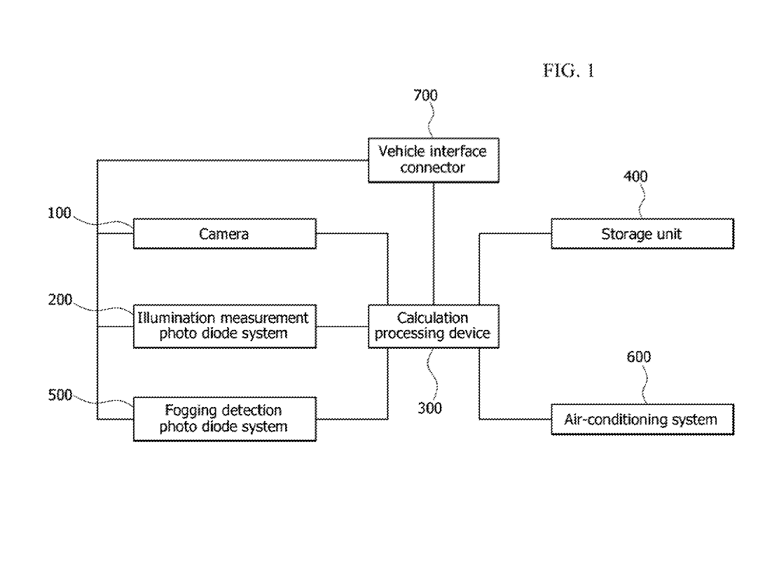

FIG. 1 is a block diagram illustrating a system for recognizing surroundings of a vehicle according to the present invention; and

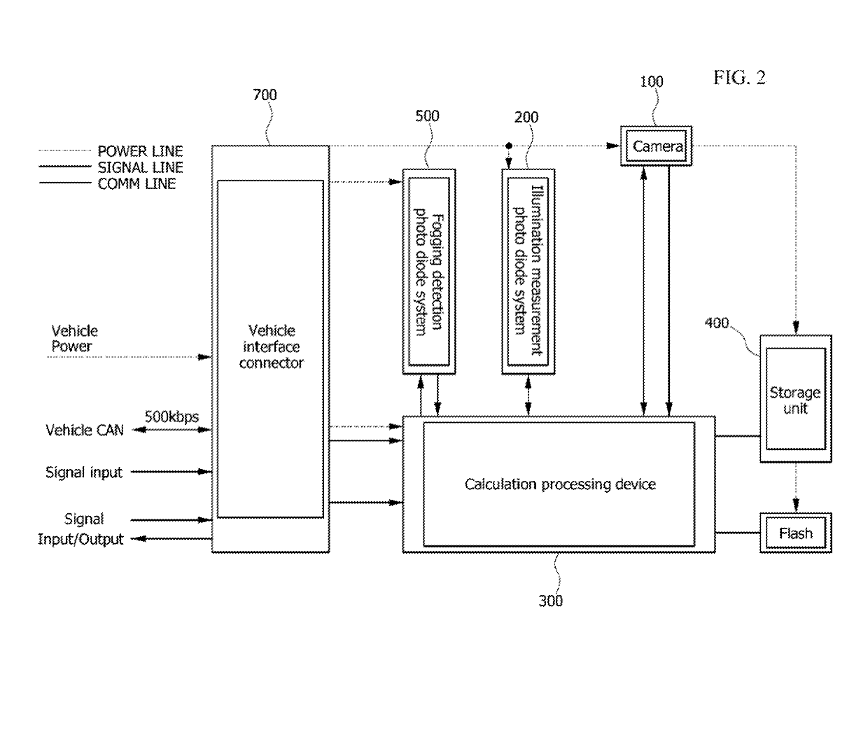

FIG. 2 is a block diagram illustrating flow of power and signals of the system for recognizing surroundings of the vehicle according to the present invention.

### DETAILED DESCRIPTION OF THE INVENTION

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

FIG. 1 is a block diagram illustrating a system for recognizing surroundings of a vehicle according to the present invention, and FIG. 2 is a block diagram illustrating flows of power and signals of the system for recognizing surroundings of the vehicle according to the present invention.

As shown in FIGS. 1 and 2, a system for recognizing surroundings of a vehicle according to an embodiment of the present invention is mounted on a vehicle, and includes a camera 100 configured to output image information obtained by photographing an image of surroundings of the vehicle, an illumination measurement photo diode system 200 configured to measure illumination of the vehicle surroundings to output illumination information, a calculation processing device 300 configured to receive the image information from the camera 100 and receive the illumination information from the illumination measurement photo diode system 200 to generate and output vehicle surroundings information, and a storage unit 400 configured to receive and store the vehicle surroundings information generated by the calculation processing device 300.

The calculation processing device 300 may correct the brightness of the image information received from the camera 100 to generate the vehicle surroundings information using the illumination information received from the illumination measurement photo diode system 200.

The calculation processing device 300 may be able to solve the problems such as light reflection generated due to the bright forward side in the running direction of the vehicle and difficulties in recognition of a subject within a field of vision or a circumstance upon a traffic accident when the forward side in the running direction of the vehicle is dark, and to correct the brightness of the image information received from the camera 100 using the illumination information of the surroundings of the vehicle varied due to streetlamps around the vehicle and taillights or headlights of neighboring vehicles, thereby more accurately recognizing the vehicle surroundings.

Meanwhile, the calculation processing device 300 may switch a photographing mode of the camera 100 when the illumination measured by the illumination measurement photo diode system 200 is a preset illumination or less, thereby performing the exposure control and more accurately recognizing the vehicle surroundings even at nighttime.

That is, the calculation processing device 300 may switch photographing modes of the camera 100, which are constituted by 10 or more different modes, such that the exposure control of the camera 100 is gradationally performed to make the camera 100 more accurately photograph the vehicle surroundings even at dark surroundings.

Accordingly, the photographing modes of the camera 100 may be divided according to sections of the exposure control into ten or more, and the photographing modes of the camera 100 may be configured to correspond to the respective sections of the exposure control.

Meanwhile, the system for recognizing surroundings of the vehicle according to the embodiment of the present invention may further include a known fogging detection photo diode system 500 configured to detect a fogging phenomenon of a window of the vehicle to output fogging information, and the fogging detection photo diode system 500 may generate and output fogging information when vapor is condensed on the windshield of the vehicle due to a temperature difference between the inside and the outside of the vehicle to generate the fogging phenomenon.

When the fogging information output from the fogging detection photo diode system 500 is input into the calculation processing device 300 and a fogging level of the vehicle measured by the fogging detection photo diode system 500 is a preset level or more, the calculation processing device 300 may set the photographing mode of the camera 100 to a fogging phenomenon photographing mode.

As the embodiment of the present invention, the calculation processing device 300 may set the camera 100 to the fogging phenomenon photographing mode, and perform imaging processing to prevent generation of malfunctions of the camera 100 in a state in which the fogging is recognized within a photographing field of vision of the camera.

In addition, when the calculation processing device 300 may set the photographing mode of the camera 100 to the fogging phenomenon photographing mode, the calculation processing device 300 may output a fogging removal command, and an air-conditioning system 600 that receives the fogging removal command from the calculation processing device 300 blows air, from which moisture is removed, to the window of the vehicle to remove the fogging phenomenon of the vehicle window, thereby enabling the camera 100 to more accurately photograph the vehicle surroundings.

Meanwhile, the system for recognizing surroundings of the vehicle according to the embodiment of the present invention may further include a vehicle interface connector 700, and the vehicle interface connector 700 may be connected to the camera 100, the illumination measurement photo diode system 200, the fogging detection photo diode system 500 and the calculation processing device 300 to supply power thereto.

Meanwhile, the camera 100, the illumination measurement photo diode system 200, the fogging detection photo diode system 500 and the calculation processing device 300 may be configured to share the vehicle interface connector 700 connected to the vehicle to obtain an internal space of the vehicle, thereby increasing spatial utilization.

In the vehicle surroundings recognition system according to the present invention, the calculation processing device can correct the brightness of the image around the vehicle photographed by the camera using the illumination information measured by the illumination measurement photo diode system to generate the vehicle surroundings information, thereby more accurately recognizing the vehicle surroundings.

In addition, in the vehicle surroundings recognition system according to the present invention, the calculation processing device can switch the photographing mode of the camera when the illumination measured by the illumination measurement photo diode is the preset illumination or less, thereby accurately recognizing the vehicle surroundings even at nighttime.

Further, in the vehicle surroundings recognition system according to the present invention, the calculation processing device can set the photographing mode of the camera to the fogging phenomenon photographing mode using the fogging information detected by the fogging detection photo diode system, thereby accurately recognizing the vehicle surroundings even when the fogging phenomenon occurs on the windshield of the vehicle.

Furthermore, since the single vehicle interface connector is provided and the vehicle interface connector is connected to the camera, the illumination measurement photo diode system, the fogging detection photo diode system and the calculation processing device to supply power thereto, a problem due to a narrowed space in the vehicle caused by preparation of the conventional interface connectors of the photo diode system and the camera can be solved to improve spatial utilization in the vehicle.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

[Description of Reference Numerals]

| | |
|---|---|
| 100: camera | 200: illumination measurement |
| | photo diode system |
| 300: calculation processing device | 400: storage unit |
| 500: fogging detection | 600: air-conditioning system |
| photo diode system | |
| 700: vehicle interface connector | |

1. A system for recognizing surroundings of a vehicle, comprising:
a camera mounted on the vehicle and configured to output image information obtained by photographing an image around the vehicle;
an illumination measurement photo diode system configured to measure illumination of vehicle surroundings to output illumination information;
a calculation processing device configured to receive the image information from the camera and receive the illumination information from the illumination measurement photo diode system to generate and output vehicle surroundings information; and
a storage unit configured to receive and store the vehicle surroundings information generated by the calculation processing device.

2. The system for recognizing surroundings of the vehicle according to claim 1, wherein the calculation processing device corrects brightness of the image information received from the camera to generate the vehicle surroundings information using the illumination information received from the illumination measurement photo diode system.

3. The system for recognizing surroundings of the vehicle according to claim 1, wherein the calculation processing device switches the photographing mode of the camera when the illumination measured by the illumination measurement photo diode system is a preset illumination or less.

4. The system for recognizing surroundings of the vehicle according to claim 1, further comprising a fogging detection photo diode system configured to detect a fogging phenomenon of a window of the vehicle and output fogging information.

5. The system for recognizing surroundings of the vehicle according to claim 4, wherein the calculation processing device receives the fogging information from the fogging detection photo diode system, and sets the photographing mode of the camera to a fogging phenomenon photographing mode when a fogging of the vehicle measured by the fogging detection photo diode system is a preset value or more.

6. The system for recognizing surroundings of the vehicle according to claim 4, wherein, when the calculation processing device sets the photographing mode of the camera to the fogging phenomenon photographing mode, the calculation processing device outputs a fogging removal command, and
further comprising an air-conditioning system configured to receive the fogging removal command from the calculation processing device, blows air, from which moisture is removed, to the window of the vehicle, and remove the fogging phenomenon of the vehicle window.

7. The system for recognizing surroundings of the vehicle according to claim 4, further comprising a vehicle interface connector connected to the camera, the illumination measurement photo diode system, the fogging detection photo diode system and the calculation processing device to supply power thereto.
